(19) United States
(12) Patent Application Publication
(10) Pub. No.: US 2026/0209019 A1
(43) Pub. Date: Jul. 23, 2026

(54) BEVERAGE CAN OPENING APPARATUS

(71) Applicant: William Koch, Williston, ND (US)

(72) Inventor: William Koch, Williston, ND (US)

(21) Appl. No.: 19/034,302

(22) Filed: Jan. 22, 2025

(51) Int. Cl. B67B 7/00

(52) U.S. Cl. CPC B67B 7/24

(57) ABSTRACT

A beverage can opening apparatus for opening a beverage can by alternative means from an integral opener tab of the beverage can includes a sleeve which fits over the beverage can. A blade holder is pivotally coupled to the sleeve, and a pair of blades is mounted to the blade holder. The pair of blades puncture the beverage can when the blade holder is pivoted toward the beverage can. The blades have rounded perimeter edges to avoid cutting skin.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to beverage can opening apparatus and more particularly pertains to a new beverage can opening apparatus for opening a beverage can by alternative means from an integral opener tab of the beverage can.

### (2) Description of Related Art Including Information Disclosed Under 37 CFR 1.97 and 1.98

The prior art includes various devices for opening beverage cans. U.S. Pat. App. No. 2004/0056033 (“the '033 Application”) discloses such a beverage can which uses a sleeve which receives a beverage can, a blade holder which pivots with respect to the sleeve, and a pair of blades for puncturing the beverage can when the blade holder is pivoted toward the beverage can. The pair of blades form a pair of slots in the beverage can so that a beverage can be poured or drunk from the beverage can through one of the slots. However, this apparatus fails to describe additional features which would make such an apparatus safer and easier to use.

For example, the blades could be formed with rounded edges so that the blades will not cut skin. A catch may be employed to prevent the blade holder from pivoting too far away from the beverage can, which can lead to pinching of fingers or other objects between the blades and the beverage can. And a strap may be employed to increase the ease of use for individuals without fingers or a hand on at least one arm. While the apparatus of the '033 Application allows a user without fingers to open a beverage can without using an opener tab of the beverage container, a strap would aid a user without fingers or a hand by providing a structure to position the user's arm in, thereby facilitating handling of the apparatus. The catch would also assist such a user in that a smaller range of motion of the blade holder would be beneficial for a person with limited grasping ability.

### BRIEF SUMMARY OF THE INVENTION

An embodiment of the disclosure meets the needs presented above by generally comprising a sleeve with an open bottom which has a size for receiving a beverage can. The sleeve also has an opening extending through a top side of the sleeve. A blade holder is pivotally coupled to the sleeve at a rear end of the blade holder. The blade holder is pivotable alternately toward and away from the top side of the sleeve. A pair of blades is coupled to the blade holder. The blades are spaced from each other and are positioned on a bottom surface of the blade holder. Each blade of the pair of blades extends downwardly through the opening of the sleeve when the blade holder lies adjacent to the top side of the sleeve. The pair of blades is configured to puncture the beverage can to form a pair of spaced slots in the beverage can when the pair of blades is urged into the beverage can. A perimeter edge of each blade of the pair of blades with respect to the blade holder is rounded wherein the blade is configured to not pierce skin when the blade is urged against the skin.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a beverage can opening apparatus according to an embodiment of the disclosure.

FIG. 2 is a top perspective view of an embodiment of the disclosure.

FIG. 3 is a bottom perspective view of an embodiment of the disclosure.

FIG. 4 is a side view of an embodiment of the disclosure.

FIG. 5 is a bottom view of an embodiment of the disclosure.

FIG. 6 is a side view of an embodiment of the disclosure.

FIG. 7 is a rear view of an embodiment of the disclosure.

FIG. 8 is a cross section view of an embodiment of the disclosure taken from Arrows 8-8 in FIG. 5.

FIG. 9 is a cross-section view of an embodiment of the disclosure taken from Arrows 9-9 in FIG. 8.

FIG. 10 is an in-use perspective view of an embodiment of the disclosure.

FIG. 11 is a perspective view of a beverage can with a pair of slots formed in a top end of the beverage can.

FIG. 12 is a perspective view of a beverage can with a pair of slots formed in a bottom end of the beverage can.

### DETAILED DESCRIPTION OF THE INVENTION

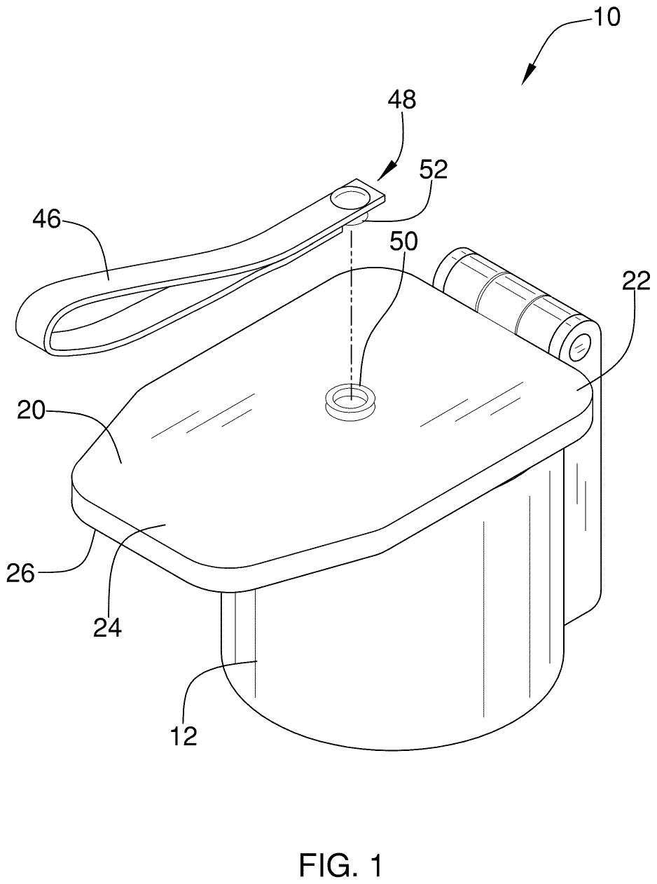

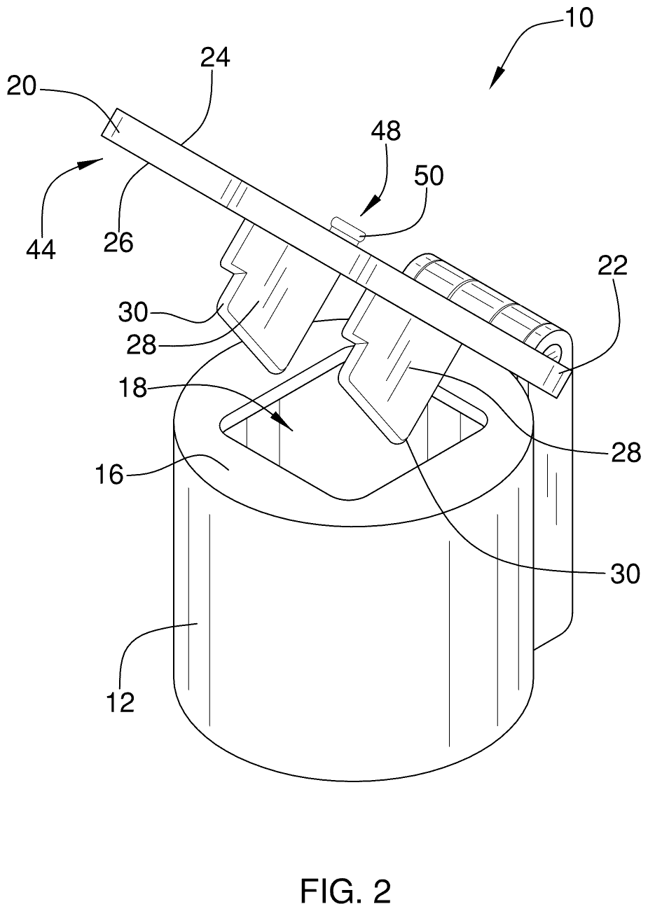

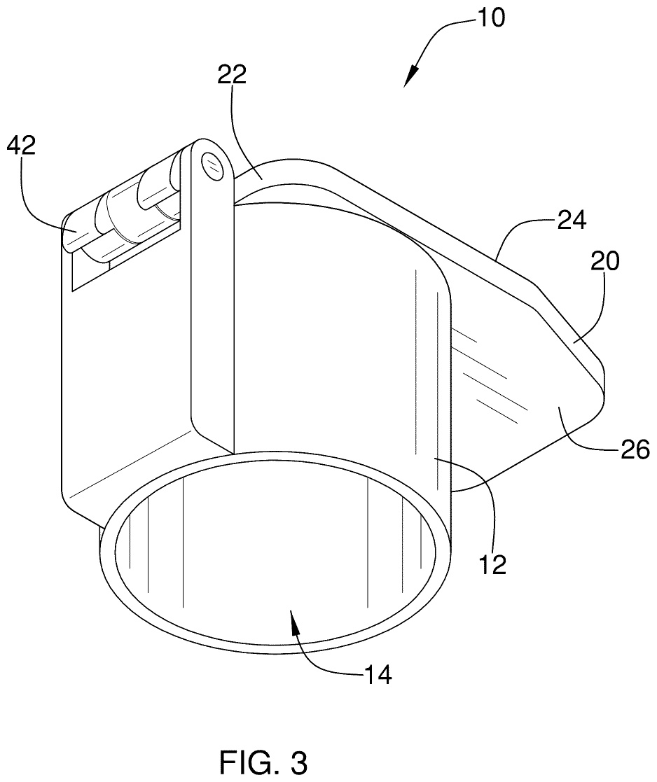

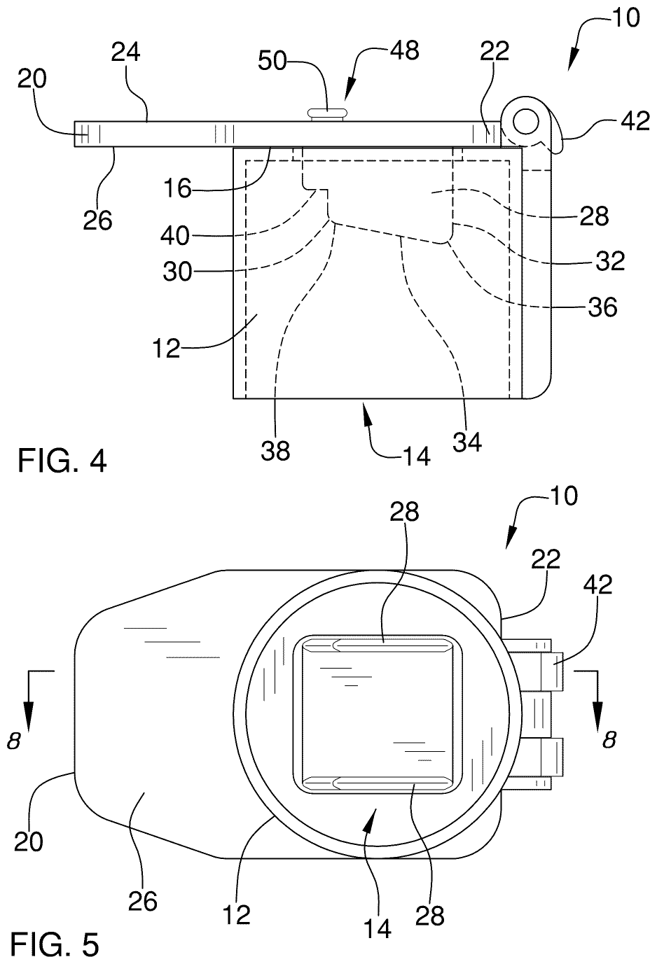

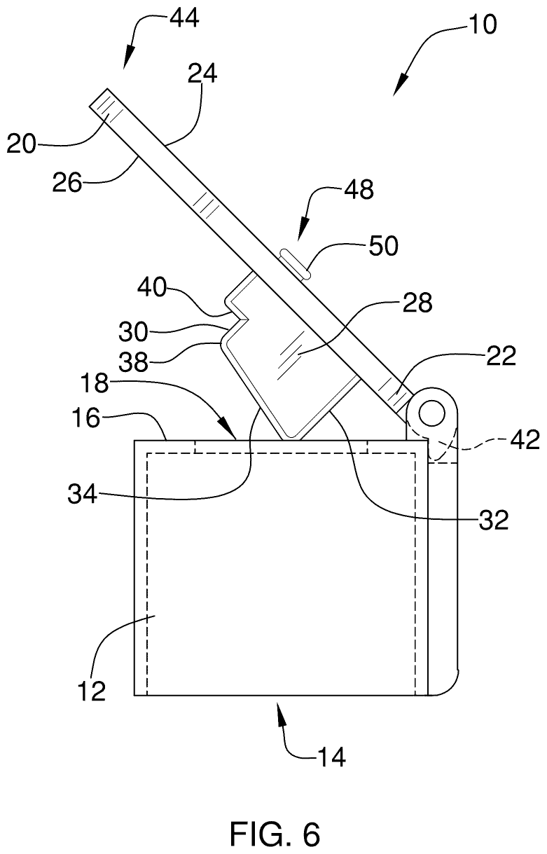

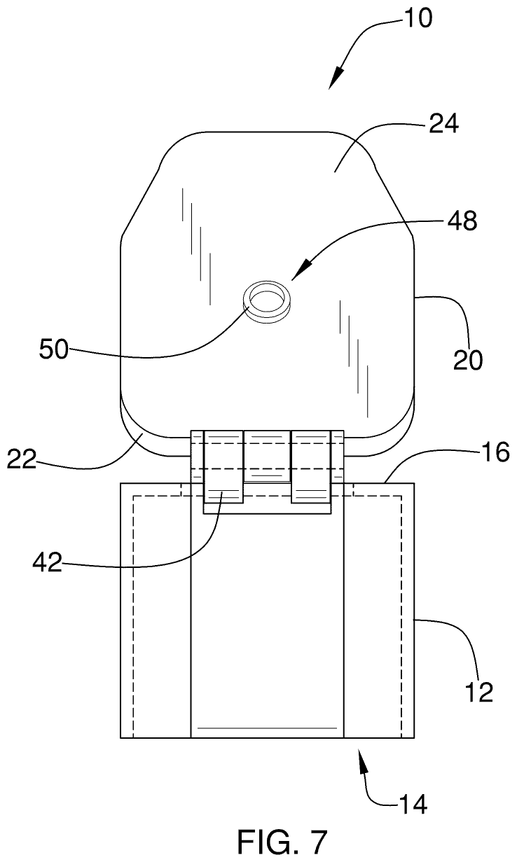

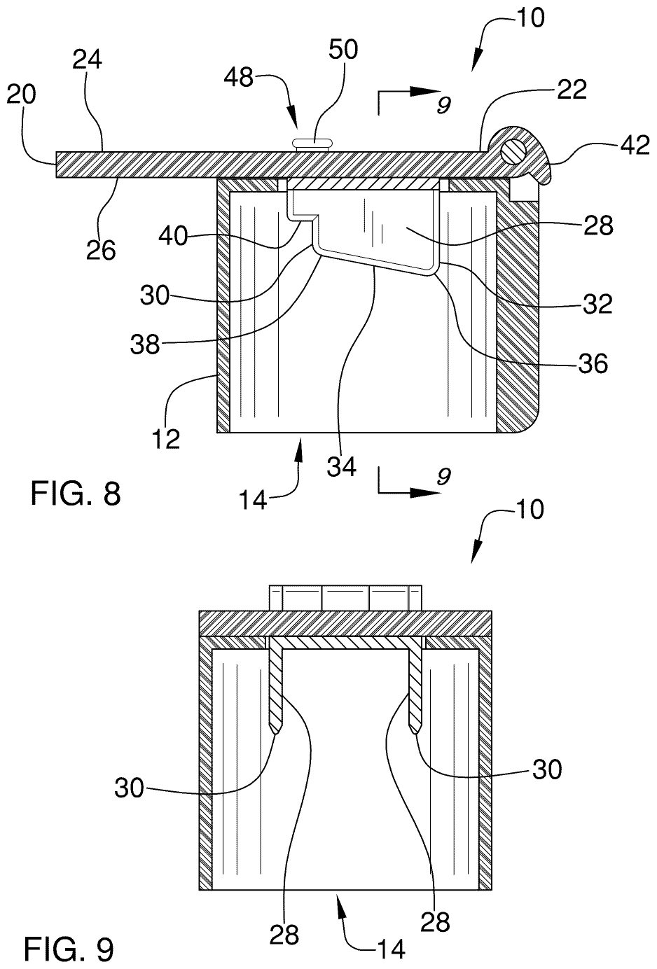

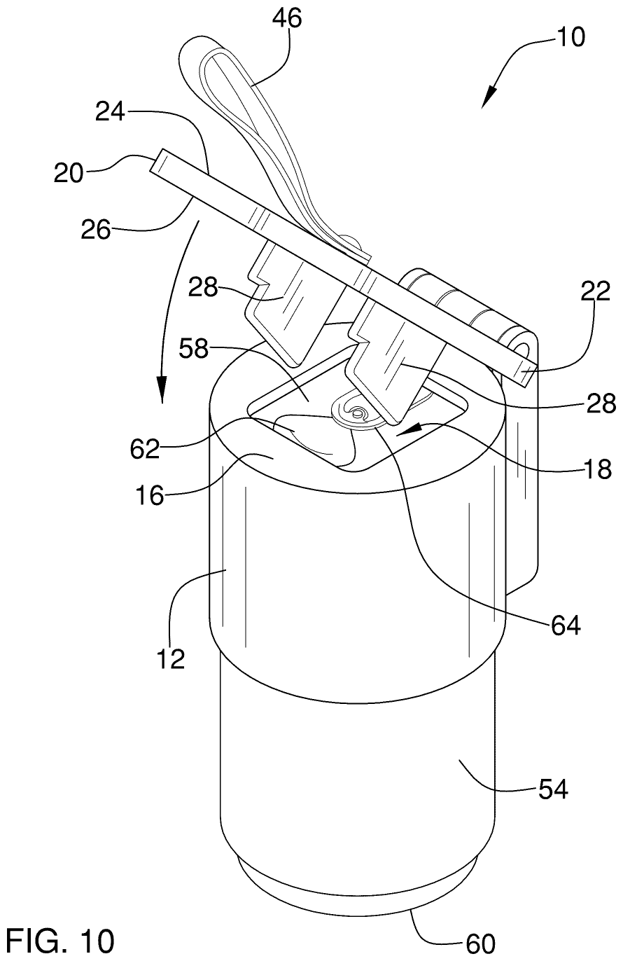

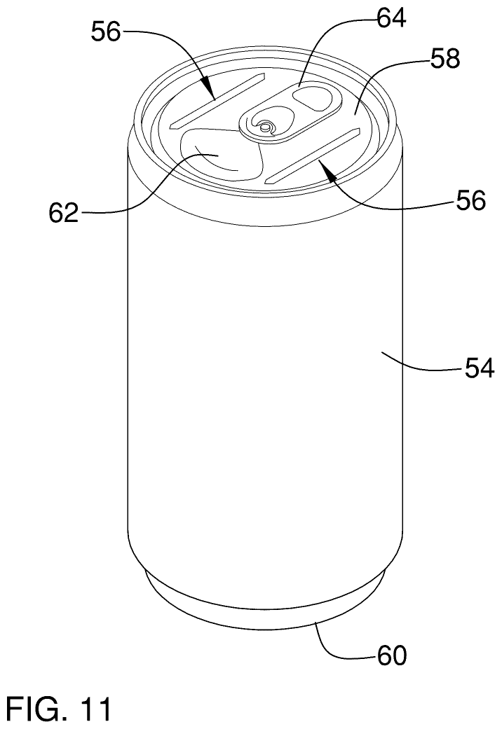

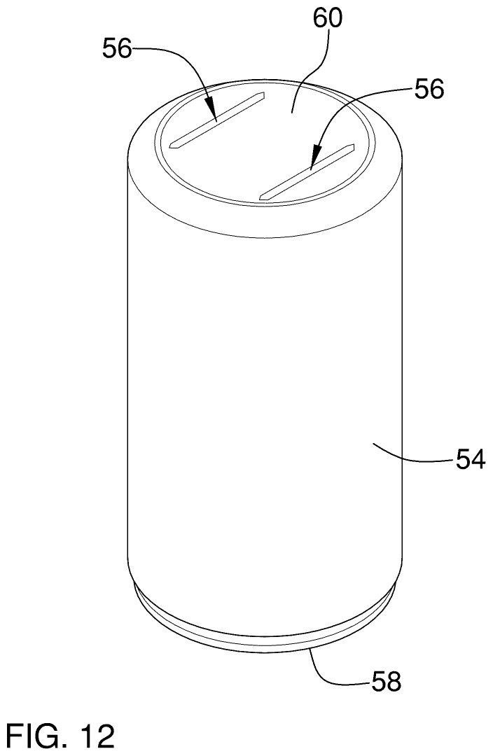

With reference now to the drawings, and in particular to FIGS. 1 through 6 thereof, a new beverage can opening apparatus embodying the principles and concepts of an embodiment of the disclosure and generally designated by the reference numeral 10 will be described.

As best illustrated in FIGS. 1 through 6, the beverage can opening apparatus 10 generally comprises a sleeve 12 with an open bottom 14 which has a size for receiving a beverage can 54. The sleeve 12 also has an opening 18 extending through a top side 16 of the sleeve 12. A blade holder 20 is pivotally coupled to the sleeve 12 at a rear end 22 of the blade holder 20. The blade holder 20 is pivotable alternately toward and away from the top side 16 of the sleeve 12. A pair of blades 28 is coupled to the blade holder 20. The blades 28 are spaced from each other, and each blade 28 of the pair of blades 28 is positioned on a bottom surface 26 of the blade holder 20. Each blade 28 of the pair of blades 28 extends downwardly through the opening 18 of the sleeve 12 when the blade holder 20 lies adjacent to the top side 16 of the sleeve 12. The pair of blades 28 is configured to puncture the beverage can 54 to form a pair of spaced slots 56 in the beverage can 54 when the pair of blades 28 is urged into the beverage can 54.

A perimeter edge 30 of each blade 28 of the pair of blades 28 with respect to the blade holder 20 is rounded wherein the blade 28 is configured to not pierce skin when the blade 28 is urged against the skin. Each blade 28 of the pair of blades 28 tapers toward the perimeter edge 30 such that the pair of blades 28 is configured to facilitate widening the slots 56 as the pair of blades 28 penetrate the beverage can 54. The perimeter edge 30 has a perpendicular portion 32 which extends away from the blade holder 20 and an inclined portion 34 which extends from a first end 36 at the perpendicular portion 32 to a second end 38. The inclined portion 34 is angled toward the blade holder 20 from the first end 36 to the second end 38. The perimeter edge 30 also has an inset portion 40 positioned at the second end 38 of the inclined portion 34 and which is inset from the inclined portion 34 toward the blade holder 20. The inset portion 40 is oriented parallel to the bottom surface 26 of the blade holder 20. Each blade 28 of the pair of blades 28 has a thickness of less than 0.25 inches. The blades 28 are spaced at a distance such that the pair of blades 28 is configured for forming the slots 56 in the beverage can 54 on opposite sides of a drinking spout 62 and an opener tab 64 of the beverage can 54. The distance is between 1.25 inches and 1.75 inches.

A catch 42 is coupled to the blade holder 20 at the rear end 22 of the blade holder 20. The catch 42 engages the sleeve 12 when the blade holder 20 pivots away from the top side 16 of the sleeve 12 to stop the blade holder 20 at a raised position 44 with respect to the sleeve 12. The blade holder 20 forms an acute angle of less than 45.0 degrees with the top side 16 of the sleeve 12 when the blade holder 20 is positioned in the raised position 44. The raised position 44 is selected to inhibit an insertion of objects, such as fingers, between the pair of blades 28 and the top side 16 of the sleeve 12.

A strap 46 is coupled to a top surface 24 of the blade holder 20 and forms a closed loop. The strap 46 facilitates handling the blade holder 20. In particular, the strap 46 facilitates use of the beverage can opening apparatus 10 by a user without fingers or a hand on one arm by receiving the one arm into the closed loop of the strap 46. Other handling means such as a rigid ring, a receiver having a cavity for receiving the arm, or the like may be used. A connector 48 releasably coupling the strap 46 to the blade holder 20. The connector 48 comprises a first mating member 50 coupled to the blade holder 20 and a second mating member 52 coupled to the strap 46. The connector 48 comprises a snap fastener, but other embodiments may use a hook-and-loop fastener, a threaded fastener, a latch, or any suitable attachment means.

In use, the beverage can 54 is inserted into the open bottom 14 of the sleeve 12 and immediately below the top side 16 of the sleeve 12. The blade holder 20 is moved toward the top side 16 of the sleeve 12, thereby forcing the pair of blades 28 against the beverage can 54. The pair of blades 28 is caused to penetrate into the beverage can 54, forming the pair of slots 56. When a beverage contained in the beverage is poured out through one of the pair of slots 56, the other slot 56 facilitates entry of air into the beverage can 54 to displace the volume of the beverage which is poured out of the beverage can 54. The thicknesses of the blades 28 are chosen to cause the slots 56 to have widths such that insects such as bees and wasps cannot gain entry into the beverage can 54. The sleeve 12 may be used to puncture either of a top end 58 and a bottom end 60 of the beverage can 54. The blades 28 taper toward the perimeter edge 30 so that, as the blades 28 are urged into the beverage can 54, the blades push the portions of the beverage can 54 bounding the slots 56 downwardly, thus keeping any sharp edges formed in the beverage can 54 within the beverage can 54 and away from a user as the user drinks from the beverage can 54.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A beverage can opening apparatus comprising:
a sleeve having an open bottom, the open bottom having a size such that the open bottom is configured for receiving a beverage can, the sleeve having an opening extending through a top side of the sleeve;
a blade holder being pivotally coupled to the sleeve at a rear end of the blade holder, the blade holder being pivotable alternately toward and away from the top side of the sleeve; and
a pair of blades being coupled to the blade holder, the blades being spaced from each other, each blade of the pair of blades being positioned on a bottom surface of the blade holder, each blade of the pair of blades extending downwardly through the opening of the sleeve when the blade holder lies adjacent to the top side of the sleeve, the pair of blades being configured to puncture the beverage can to form a pair of spaced slots in the beverage can when the pair of blades is urged into the beverage can, a perimeter edge of each blade of the pair of blades with respect to the blade holder being rounded wherein the blade is configured to not pierce skin when the blade is urged against the skin.

2. The apparatus of claim 1, wherein each blade of the pair of blades tapers toward the perimeter edge such that the pair of blades is configured to facilitate widening the slots as the pair of blades penetrate the beverage can, the perimeter edge having a perpendicular portion which extends away from the blade holder and an inclined portion which extends from a first end at the perpendicular portion to a second end, the inclined portion being angled toward the blade holder from the first end to the second end.

3. The apparatus of claim 2, wherein the perimeter edge has an inset portion positioned at the second end of the inclined portion, the inset portion being inset from the inclined portion toward the blade holder.

4. The apparatus of claim 3, wherein the inset portion is oriented parallel to the bottom surface of the blade holder.

5. The apparatus of claim 1, wherein each blade of the pair of blades has a thickness of less than 0.25 inches.

6. The apparatus of claim 1, wherein the blades of the pair of blades are spaced a distance such that the pair of blades is configured for forming the slots in the beverage can on opposite sides of a drinking spout and an opener tab of the beverage can.

7. The apparatus of claim 6, wherein the distance being between 1.25 inches and 1.75 inches.

8. The apparatus of claim 1, further comprising a catch being coupled to the blade holder at the rear end of the blade holder, the catch engaging the sleeve when the blade holder pivots away from the top side of the sleeve to stop the blade holder at a raised position with respect to the sleeve.

9. The apparatus of claim 8, wherein the blade holder forms an acute angle with the top side of the sleeve when the blade holder is positioned in the raised position.

10. The apparatus of claim 9, wherein the acute angle is less than 45.0 degrees.

11. The apparatus of claim 1, further comprising a strap being coupled to a top surface of the blade holder and forming a closed loop.

12. The apparatus of claim 11, further comprising a connector releasably coupling the strap to the blade holder, the connector comprising a first mating member coupled to the blade holder and a second mating member coupled to the strap.

13. The apparatus of claim 12, wherein the connector comprises a snap fastener.

14. A beverage can opening apparatus comprising:
a sleeve having an open bottom, the open bottom having a size such that the open bottom is configured for receiving a beverage can, the sleeve having an opening extending through a top side of the sleeve;
a blade holder being pivotally coupled to the sleeve at a rear end of the blade holder, the blade holder being pivotable alternately toward and away from the top side of the sleeve;
a pair of blades being coupled to the blade holder, the blades being spaced from each other, each blade of the pair of blades being positioned on a bottom surface of the blade holder, each blade of the pair of blades extending downwardly through the opening of the sleeve when the blade holder lies adjacent to the top side of the sleeve, the pair of blades being configured to puncture the beverage can to form a pair of spaced slots in the beverage can when the pair of blades is urged into the beverage can, a perimeter edge of each blade of the pair of blades with respect to the blade holder being rounded wherein the blade is configured to not pierce skin when the blade is urged against the skin, each blade of the pair of blades tapering toward the perimeter edge such that the pair of blades is configured to facilitate widening the slots as the pair of blades penetrate the beverage can, the perimeter edge having a perpendicular portion which extends away from the blade holder and an inclined portion which extends from a first end at the perpendicular portion to a second end, the inclined portion being angled toward the blade holder from the first end to the second end, the perimeter edge having an inset portion positioned at the second end of the inclined portion, the inset portion being inset from the inclined portion toward the blade holder, the inset portion being oriented parallel to the bottom surface of the blade holder, each blade of the pair of blades having a thickness of less than 0.25 inches, the pair of blades being spaced a distance such that the pair of blades is configured for forming the slots in the beverage can on opposite sides of a drinking spout and an opener tab of the beverage can, the distance being between 1.25 inches and 1.75 inches;
a catch being coupled to the blade holder at the rear end of the blade holder, the catch engaging the sleeve when the blade holder pivots away from the top side of the sleeve to stop the blade holder at a raised position with respect to the sleeve, the blade holder forming an acute angle with the top side of the sleeve when the blade holder is positioned in the raised position, the acute angle being less than 45.0 degrees;
a strap being coupled to a top surface of the blade holder and forming a closed loop; and
a connector releasably coupling the strap to the blade holder, the connector comprising a first mating member coupled to the blade holder and a second mating member coupled to the strap, the connector comprising a snap fastener.
